(19) United States
(12) Patent Application Publication
(10) Pub. No.: US 2007/0126207 A1
(43) Pub. Date: Jun. 7, 2007

(54) Combination infant carriage and utility cart

(75) Inventors: Rebecca Rojas, Pembroke Pines, FL (US); Michael Anthony, Coral Springs, FL (US)

Correspondence Address: Mark D. Bowen;Stearns Weaver Miller, Suite 2100, 200 East Las Olas Boulevard, Fort Lauderdale, FL, 33301, US

(73) Assignee: Rebecca Rojas

(21) Appl. No.: 11/296,042

(22) Filed: Dec. 7, 2005

(51) Int. Cl. B62B 7/00

(52) U.S. Cl. 280/647

(57) ABSTRACT

An infant carriage transport apparatus, adapted with a large storage bin. By providing a utility cart having a conventional child seat combined with substantial load carrying capacity, the present invention allows a caregiver to simultaneously transport a child along with substantial loads of laundry, groceries, and the like. The utility cart includes a collapsible frame assembly adapted with a plurality of wheels, handles for pushing, an infant seat, and at least one large capacity storage bin. In various embodiments, the storage bin may be located is located toward the front or rear of the cart and provides a deep, large volume compartment suitable for receiving large loads of laundry, grocery bags, etc. The storage bin is defined by flexible fabric walls that include at least one opening and closing portion for providing access. The utility cart may further be adapted with one or more rearwardly disposed shelves and a removable top mounted tray configured with partitions and cup holders.

### CROSS REFERENCE TO RELATED APPLICATIONS

N/A

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

The present invention relates to wheeled human transporters such as infant carriages and strollers for transporting children, and more particularly, to a combination carriage and utility cart adapted with large capacity storage bins.

2. Description of Related Art

Human transporters, such as strollers for transporting children are well known. Typically, such devices include a frame having a plurality of wheels and adapted with a seat for transporting a child. Strollers are further often adapted with a small storage area or compartment. While conventional strollers are generally well suited for transporting children, they often lack sufficient storage capacity. Accordingly, there exists a need for an improved stroller adapted with a large storage capacity sufficient for holding and transporting loads of laundry, grocery bags, diaper bags and baby accessories, and other articles.

### BRIEF SUMMARY OF THE INVENTION

The present invention overcomes the limitations in the art by providing a stroller or other wheeled chair transport apparatus, adapted with a large storage bin. By providing a stroller having a conventional child seat combined with substantial load carrying capacity, the present invention allows a caregiver to simultaneously transport a child along with substantial loads of laundry, groceries, and the like. A stroller in accordance with the present invention includes a collapsible frame assembly adapted with a plurality of wheels, handles for pushing, an infant seat, and at least one large capacity storage bin. In a preferred embodiment, the storage bin is located toward the rear of the stroller and provides a deep, large volume compartment suitable for receiving large loads of laundry, grocery bags, etc. The storage bin may be defined by flexible fabric walls that include at least one opening and closing portion for providing access. The stroller may further be adapted with one or more rearwardly disposed shelves and a removable top mounted tray configured with partitions and cup holders.

Accordingly, it is an object of the present invention to provide an improved child stroller.

Another object of the present invention is to provide a combination stroller and utility cart.

Still another object of the present invention is to provide a combination stroller and utility cart that is collapsible.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a front perspective view of a combination infant carriage and utility cart in accordance with the present invention;

FIG. 2 is a rear perspective view thereof;

FIG. 3 is a right side perspective view thereof;

FIG. 4 is a left side perspective view thereof;

FIG. 5 is a rear perspective view of an alternate embodiment rear facing combination infant carriage and utility cart in accordance with the present invention;

FIG. 6 is a top perspective view thereof;

FIG. 7 is a bottom perspective view thereof;

FIG. 8 is a front perspective view of alternate embodiment lightweight combination infant carriage and utility cart;

FIG. 9 is a rear perspective view thereof;

FIG. 10 is left side exploded perspective view thereof; and

FIG. 11 is a front exploded perspective view thereof.

### DETAILED DESCRIPTION OF THE INVENTION

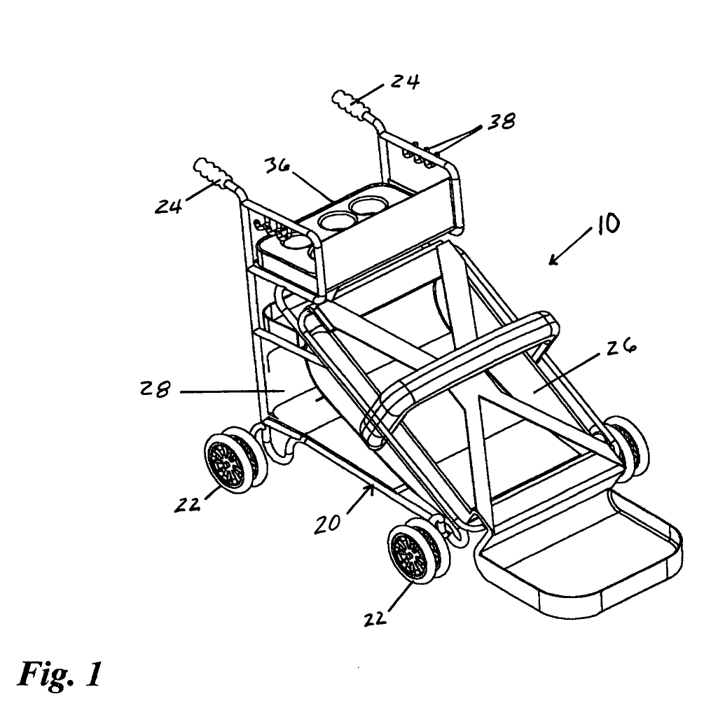

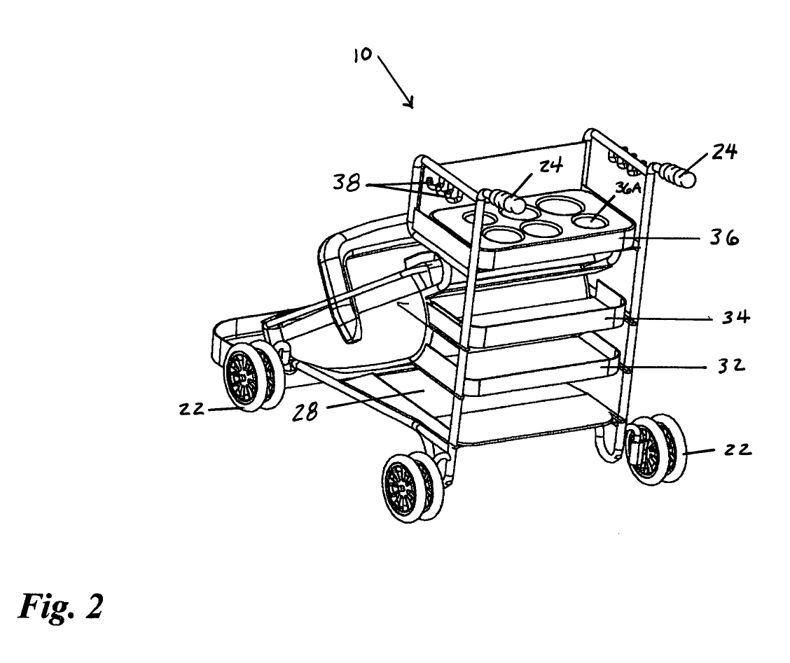

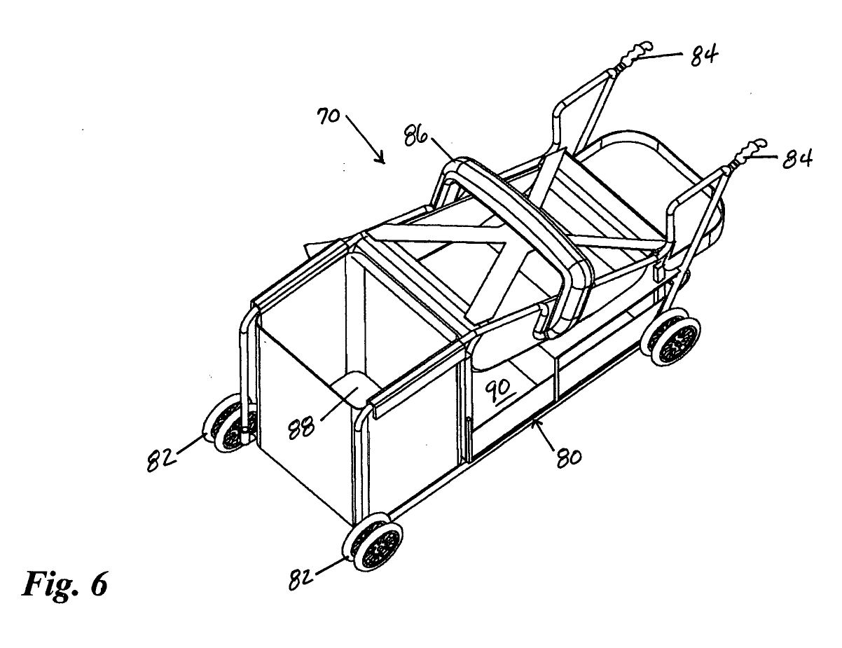

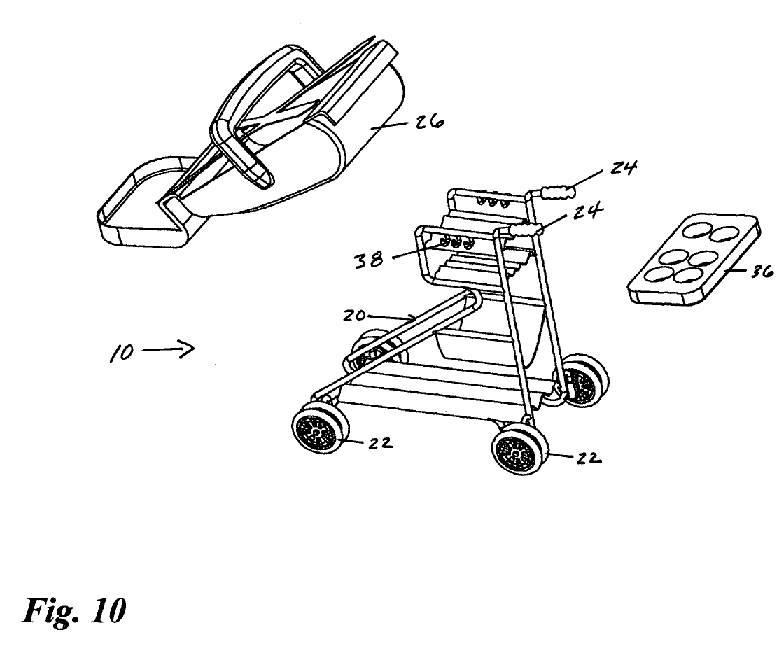

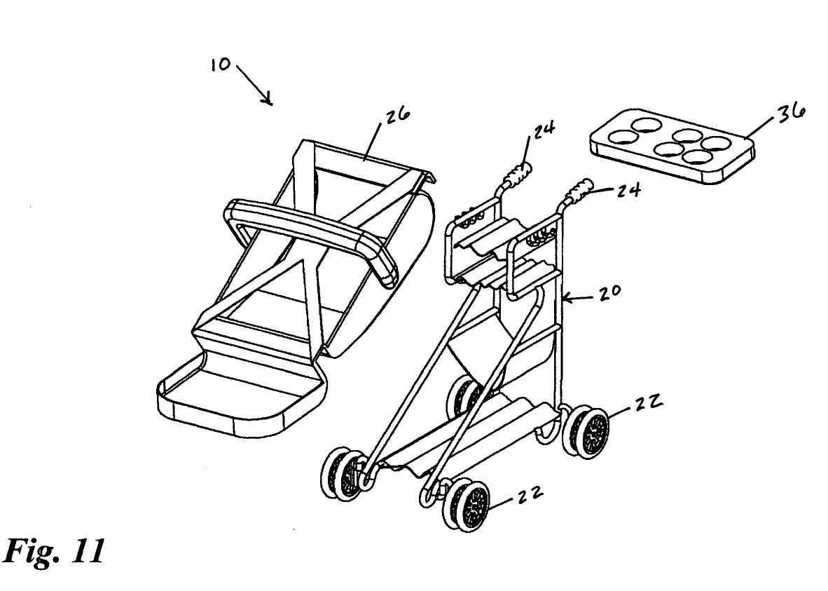

Turning now to the drawings, FIGS. 1-11 depict preferred and alternate embodiments of a utility cart adapted with a child seat and a large storage bin in accordance with the present invention. FIGS. 1-4 depict a preferred embodiment for such a utility cart, generally referenced as 10, adapted with a child seat in a forward facing configuration. Utility cart 10 includes a collapsible frame assembly, generally referenced as 20, adapted with a plurality of wheels 22, handles 24 for pushing, an infant seat 26, and at least one large capacity storage bin 28. Infant seat 26 is preferably removable such that utility cart 10 may be used soley to transport articles and goods. As best depicted in FIG. 2, storage bin 28 is located toward the rear of the stroller and provides a deep, large volume compartment suitable for receiving large loads of laundry, grocery bags, etc. Storage bin 28 may further be adapted with one or more horizontally disposed shelves, referenced as 32 and 34, and a removable top mounted tray 36 configured with partitions and/or cup holders 36A. Storage bin 28 may be defined by flexible fabric walls that include at least one opening and closing portion for providing access. Frame 20 may further include an upper portion having attached, generally J-shaped hooks, referenced as 38, for use in carrying plastic grocery bags. By providing a stroller having a conventional child seat combined with substantial load carrying capacity, the present invention allows a caregiver to simultaneously transport a child along with substantial loads of laundry, groceries, and the like. Finally, FIGS. 10 and 11 illustrate the collapsibility features of utility cart 10. More particularly, infant seat 26 may be removed, and frame members 20 may be collapsed such that the left and right sides are brought into substantially adjacent relation.

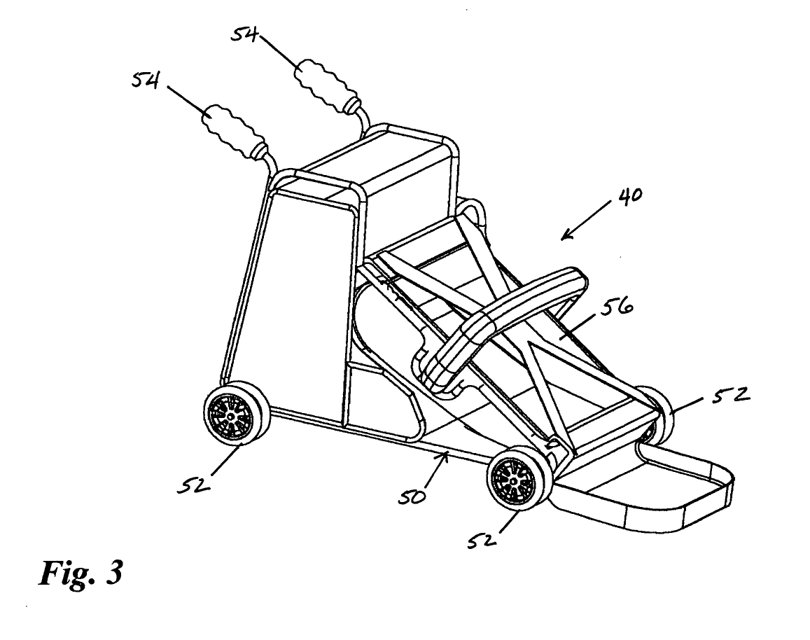

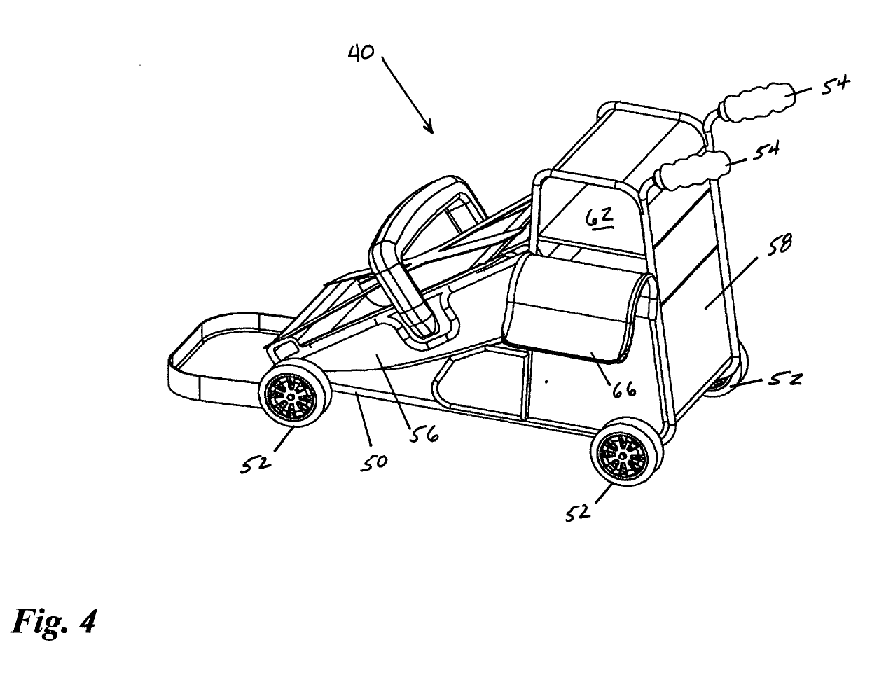

FIGS. 3 and 4 depict an alternate embodiment utility cart, referenced as 40, also adapted with a removable, forward-facing child seat. Utility cart 40 includes a collapsible frame assembly, generally referenced as 50, adapted with a plurality of wheels 52, handles 54 for pushing, an infant seat 56, and at least one large capacity storage bin 58. Infant seat 56 is preferably removable such that utility cart 40 may be used soley to transport articles and goods. As best depicted in FIG. 4, storage bin 58 is located toward the rear of the stroller and provides a deep, large volume compartment suitable for receiving large loads of laundry, grocery bags, etc. Storage bin 58 may further be adapted with one or more horizontally disposed shelves, referenced as 62 and 64. Storage 126, and at least one large capacity storage bin 128. Infant seat 126 is a formed of fabric connected to frame 120 in a sling configuration, and may be used to transport articles and goods as well. Storage bin 128 is located toward the rear of the stroller and provides a deep, large volume compartment suitable for receiving large loads of laundry, grocery bags, etc. Storage bin 128 may be defined by flexible fabric walls that include at least one opening and closing portion, referenced as 129 for providing access. By providing a stroller having a conventional child seat combined with substantial load carrying capacity, the present invention allows a caregiver to simultaneously transport a child along with substantial loads of laundry, groceries, and the like.

The instant invention has been shown and described herein in what is considered to be the most practical and preferred embodiment. It is recognized, however, that departures may be made therefrom within the scope of the invention and that obvious modifications will occur to a person skilled in the art. bin 58 may be defined by flexible fabric walls 66 that include at least one opening and closing portion for providing access as best seen in FIG. 4.

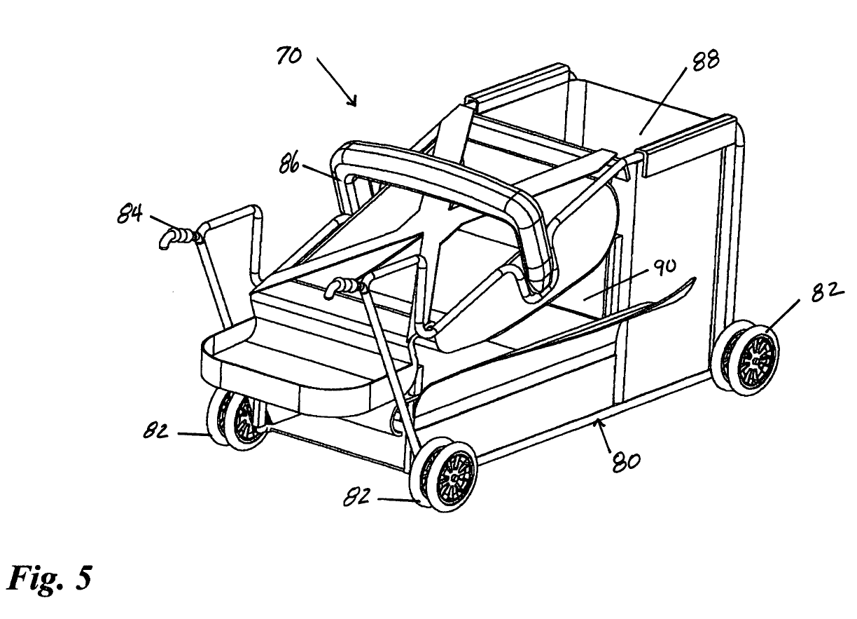

FIGS. 5-7 depict an alternate embodiment utility cart, referenced as 70, adapted with a removable rear-facing infant seat in accordance with the present invention. Utility cart 70 includes a collapsible frame assembly, generally referenced as 80, adapted with a plurality of wheels 82, handles 84 for pushing, and a removable infant seat 86. Utility cart 70 further includes a plurality of storage bins and areas, including a forwardly disposed large capacity primary storage bin 88, and a secondary, lower storage area 90. Primary storage bin 88 is preferably bounded by lightweight fabric sidewalls and defines a large deep open storage area. Secondary storage area 90 is generally disposed below infant seat 88, is bounded by lightweight fabric sidewalls, at least one of which sidewalls is openable as illustrated in FIG. 5. As noted above, infant seat 86 is preferably removable such that utility cart 70 may be used solely to transport articles and goods.

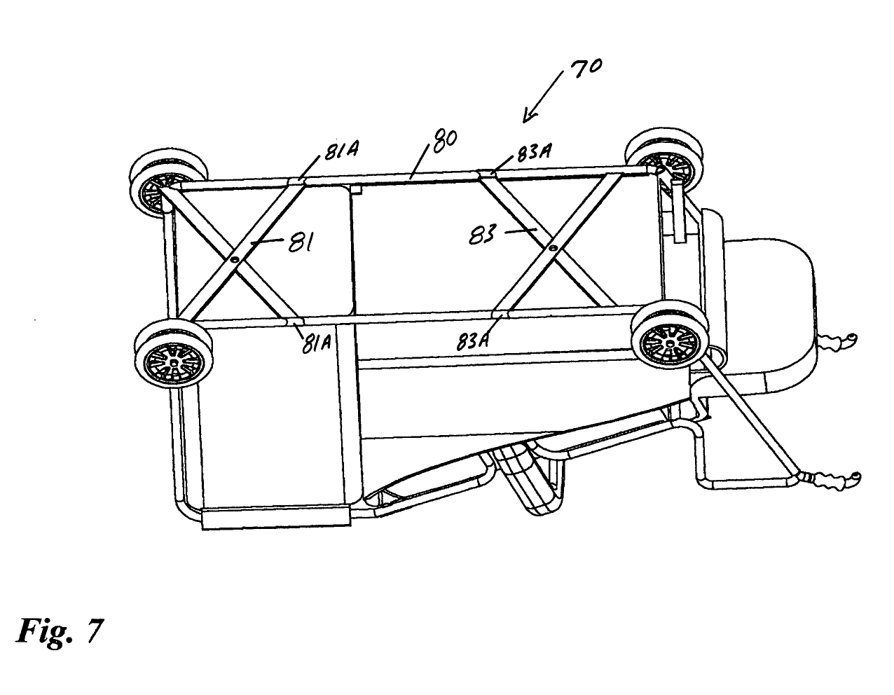

Each of the above-referenced embodiments preferably includes a collapsible frame as best illustrated in FIG. 7. More particularly, frame 80 includes left and right sides connected by pivotally connected, generally X-shaped cross braces, referenced as 81 and 83. FIG. 7 depicts frame 80 in the non-collapsed configuration suitable for use. Cross braces 81 and 83 allow frame 80 to collapse such that the left and right sides thereof move to substantially adjacent, side-to-side relation as best illustrated with the embodiment depicted in FIGS. 10 and 11. This may be accomplished by adapting the brace ends, referenced as 81A and 83A, with sleeves in surrounding slidable engagement with frame 80.

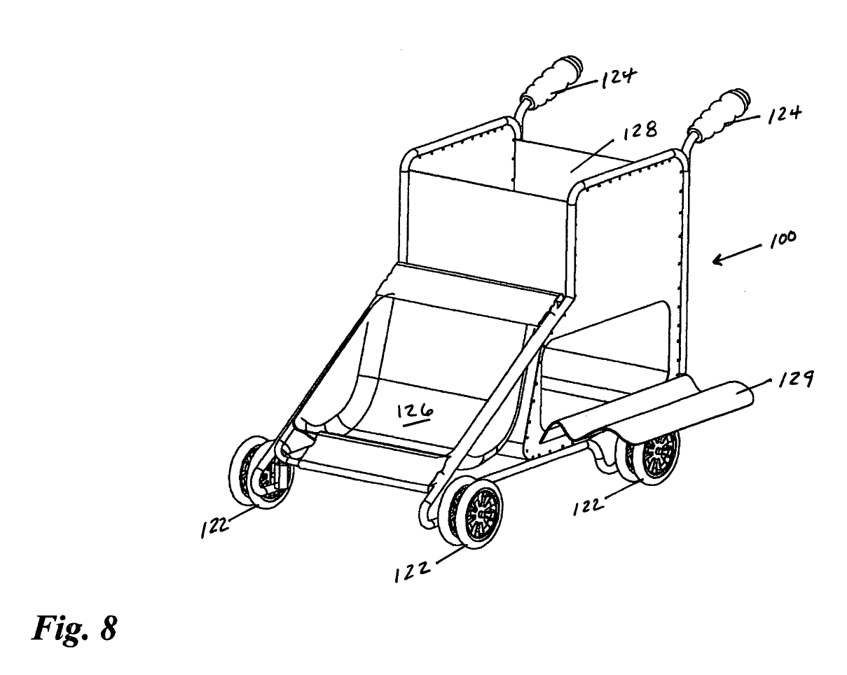

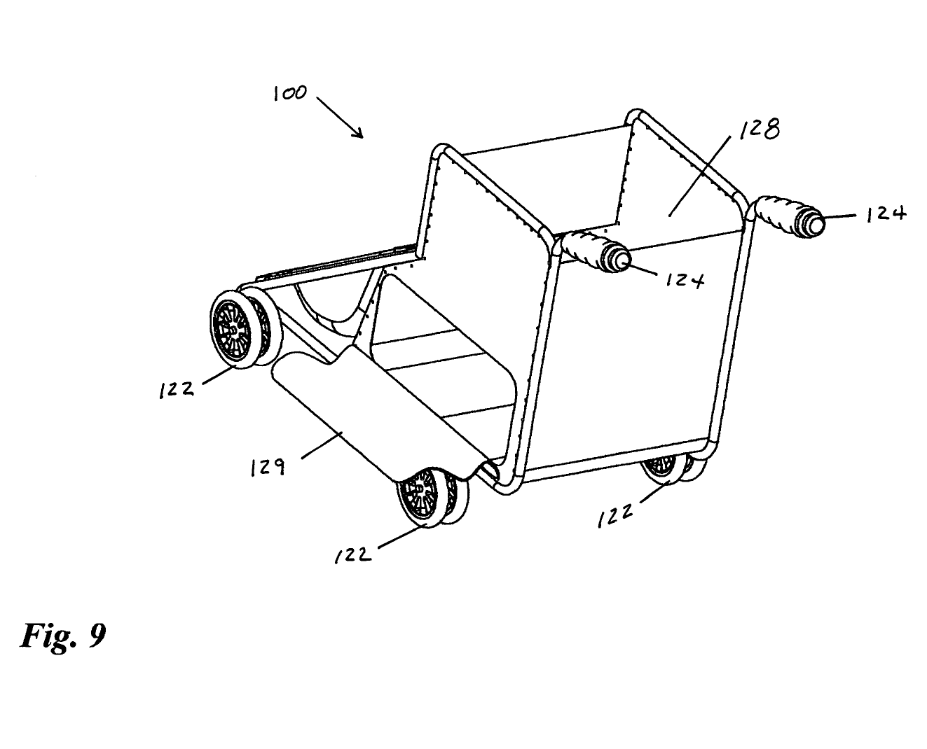

FIGS. 8 and 9 depict a lightweight embodiment for a utility cart, generally referenced as 100, of the present invention. Utility cart 100 includes a collapsible frame assembly, generally referenced as 120, adapted with a plurality of wheels 122, handles 124 for pushing, an infant seat

What I claim is:

1. A collapsible utility cart comprising:
a frame having left and right sides, a bottom portion adapted with wheels, and a top portion adapted with handles;
an infant seat removably attachable to said frame;
said frame further including a storage bin defined by a fabric bottom and fabric sides;
a plurality of generally J-shaped hooks attached to said frame; and
means for collapsing said frame in a configuration wherein said left and right sides are substantially adjacent.

2. A collapsible utility cart according to claim 1, wherein at least one of said storage bind fabric sides includes an openable flap.

3. A collapsible utility cart according to claim 1, further including a removably attachable utensil tray adapted with at least one cup holder.

4. A collapsible utility cart comprising:
a frame having left and right sides, a bottom portion adapted with wheels, and a top portion adapted with handles;
said frame top portion further including a plurality of generally J-shaped hooks projecting laterally from each of said left and right sides;
an infant seat removably attachable to said frame;
said frame further including a storage bin defined by a fabric bottom and fabric sides, at least one of said fabric sides including an openable flap; and
means for collapsing said frame in a configuration wherein said left and right sides are substantially adjacent.

5. A collapsible utility cart according to claim 4, wherein said left and right frame sides are connected by a pair of pivotally connected cross brace members, each of said cross brace members including an end adapted with a sleeve disposed in sliding relation with one of said frame sides.
